(19) United States
(12) Patent Application Publication
(10) Pub. No.: US 2025/0224016 A1
(43) Pub. Date: Jul. 10, 2025

(54) HYBRID STEEL-SHAPE MEMORY ALLOY ENERGY DISSIPATION SYSTEM

(71) Applicant: Texas State University, San Marcos, TX (US)

(72) Inventors: Ahmet Güllü, Istanbul (TR); Togay Ozbakkaloglu, San Marcos, TX (US)

(21) Appl. No.: 18/991,648

(22) Filed: Dec. 22, 2024

Related U.S. Application Data
(60) Provisional application No. 63/618,242, filed on Jan. 5, 2024.

(51) Int. Cl. F16F 15/073; F16F 1/02; F16F 1/18; F16F 1/26

(52) U.S. Cl. CPC F16F 15/073; F16F 1/021; F16F 1/187; F16F 1/26; F16F 2224/0258

(57) ABSTRACT

A hybrid steel-shape memory alloy energy dissipation system with high energy dissipation and self-centering capability. The dissipation system includes a damper that consists of a steel portion and a shape memory alloy portion, where the steel portion and the shape memory alloy portion are fixed to each other, such as via a bolt configuration. The steel portion of the damper may have an oval shape, and the shape memory alloy portion of the damper may have an S-shape form. In this manner, by implementing a damper that consists of both a steel portion and a shape memory alloy portion fixed to each other, loading velocity rate dependency, loss of viscosity, and residual displacements of the main structure are addressed by combining the advantages of a high damping force and stable hysteretic behavior of steel and the superelastic characteristics of the shape memory alloy (e.g., Ni—Ti).

### TECHNICAL FIELD

The present disclosure relates generally to energy dissipation systems, and more particularly to a hybrid steel-shape memory alloy energy dissipation system with high energy dissipation and self-centering capability.

### BACKGROUND

Energy dissipation systems are increasingly being used for damage mitigation induced by earthquakes and other hazards, such as strong wind, storms, hurricanes, and tsunamis that may strike structures and infrastructure. The capabilities of such systems in reducing structural vibrations, demonstrated by past hazardous events, make them particularly desirable for both new and existing strategic structures, such as police stations, schools, hospitals, and nuclear power plants and critical infrastructure, such as bridges, tunnels, and sea walls.

An example of an energy dissipation system includes passive energy dissipation systems, which are designed to absorb and dissipate energy without the need for external power. These systems may be made from a variety of materials, such as rubber, steel and other metals.

Another example of an energy dissipation system includes semi-active energy dissipation systems, which use external power to adjust their stiffness or damping properties.

A further example of an energy dissipation system includes active energy dissipation systems, which use external power to actively control the response to natural hazards.

Unfortunately, the damping mechanisms (means by which oscillation amplitudes are reduced through irreversible removal of vibratory energy in a mechanical system or a component) of such energy dissipation systems exhibit loading velocity rate dependency (depend on the rate at which forces are applied), loss of viscosity (frictional loss in fluids), and residual displacements of the main structure (permanent displacements attained by the structure due to a natural hazard, such as an earthquake).

### SUMMARY

In one embodiment of the present disclosure, a damper comprises a steel portion and a shape memory alloy portion, where the steel portion and the shape memory alloy portion are fixed to each other.

The foregoing has outlined rather generally the features and technical advantages of one or more embodiments of the present disclosure in order that the detailed description of the present disclosure that follows may be better understood. Additional features and advantages of the present disclosure will be described hereinafter which may form the subject of the claims of the present disclosure.

### BRIEF DESCRIPTION OF THE DRAWINGS

A better understanding of the present disclosure can be obtained when the following detailed description is considered in conjunction with the following drawings, in which:

FIG. 1 illustrates a hybrid cushion damper with steel and shape memory alloy parts in accordance with an embodiment of the present disclosure;

FIG. 2 illustrates the finite element model of the hybrid cushion damper in accordance with an embodiment of the present disclosure;

FIGS. 3A-3C illustrate application scenarios of the hybrid cushion damper in accordance with an embodiment of the present disclosure;

FIG. 4 shows the model-predicted and the experimental tensile stress vs. strain response of the Ni—Ti material at room temperature in accordance with an embodiment of the present disclosure;

FIGS. 5A-5C illustrate the model responses of the superelastic Ni—Ti under varying strain paths in accordance with an embodiment of the present disclosure;

FIG. 6 illustrates the model stress versus the stress response of the superelastic Ni—Ti under the tensile and compressive strain of ±0.05 to demonstrate the effect of the tension-compression asymmetry (TCA) model parameters (c, d) in accordance with an embodiment of the present disclosure;

FIGS. 7A-7B illustrate case A and case B, respectively, in connection with the imposed cyclic loadings to finite element models (FEMs) in accordance with an embodiment of the present disclosure;

FIG. 8 illustrates defining the maximum shear angle, γ, in accordance with an embodiment of the present disclosure;

FIGS. 9A-9B illustrate displacement (in mm) for case A and B, respectively, versus force (kN) in accordance with an embodiment of the present disclosure;

FIG. 10 illustrates the numerical modeling strategy in accordance with an embodiment of the present disclosure;

FIG. 11 compares the energy dissipated by SC (E_{SC}), SmaC (E_{SmaC}), and the structural members (Eₚ) in accordance with an embodiment of the present disclosure; and

FIG. 12 illustrates the residual drift responses of the moment resisting frames with different cushion damper arrangements in accordance with an embodiment of the present disclosure.

### DETAILED DESCRIPTION

As stated above, energy dissipation systems are increasingly being used for damage mitigation induced by earthquakes and other hazards, such as strong wind, storms, hurricanes, and tsunamis that may strike structures and infrastructure. The capabilities of such systems in reducing structural vibrations, demonstrated by past hazardous events, make them particularly desirable for both new and existing strategic structures, such as police stations, schools, hospitals, and nuclear power plants and critical infrastructure, such as bridges, tunnels, and sea walls.

An example of an energy dissipation system includes passive energy dissipation systems, which are designed to absorb and dissipate energy without the need for external power. These systems may be made from a variety of materials, such as rubber, steel and other metals.

Another example of an energy dissipation system includes semi-active energy dissipation systems, which use external power to adjust their stiffness or damping properties.

A further example of an energy dissipation system includes active energy dissipation systems, which use external power to actively control the response to natural hazards.

Unfortunately, the damping mechanisms (means by which oscillation amplitudes are reduced through irreversible removal of vibratory energy in a mechanical system or a component) of such energy dissipation systems exhibit loading velocity rate dependency (depend on the rate at which forces are applied), loss of viscosity (frictional loss in fluids), and residual displacements of the main structure (permanent displacements attained by the structure due to a natural hazard, such as an earthquake).

The embodiments of the present disclosure provide a means for addressing loading velocity rate dependency, loss of viscosity, and residual displacements of the main structure by combining the advantages of a high damping force and stable hysteretic behavior of steel and the superelastic characteristics of the shape memory alloy (e.g., Ni—Ti, Fe-based, Cu-based) to form a hybrid steel-shape memory alloy energy dissipation system with high energy dissipation and self-centering capability. In one embodiment, such a dissipation system includes a damper with steel and shape memory alloy parts. In one embodiment, these two different metals are fixed to each other by engineered bolt configurations. In one embodiment, the steel portion of the damper has an oval shape, and the memory portion of the damper has an S-shape form. In one embodiment, the number of curves of the memory alloy portion of the damper is based on the outer dimensions of the steel portion of the damper. For example, as the outer dimensions of the steel portion of the damper increase, the number of curves of the memory alloy portion of the damper is increased. A further discussion regarding these and other features is provided below.

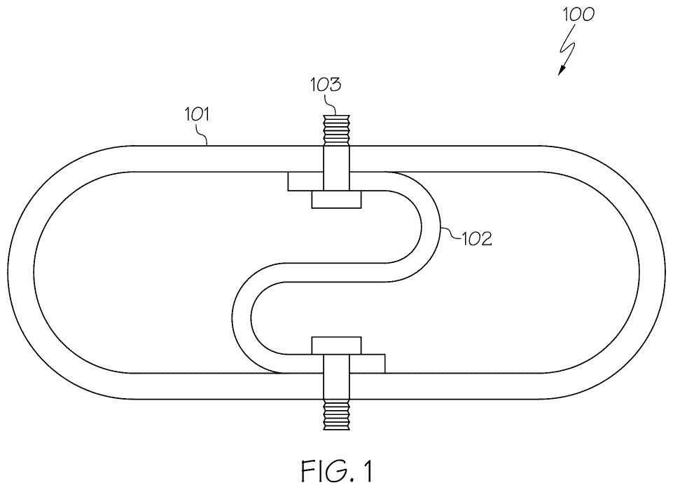

Referring now to the Figures in detail, FIG. 1 illustrates a damper (also referred to herein as the “hybrid cushion damper”) with steel and shape memory alloy parts in accordance with an embodiment of the present disclosure.

As shown in FIG. 1, hybrid cushion damper 100 includes a steel portion 101 (also simply referred to as steel 101), which may have an oval shape. Hybrid cushion damper 100 further includes a shape memory alloy 102, which may include an S-shape. In one embodiment, shape memory alloy 102 includes the material of Ni—Ti. In one embodiment, shape memory alloy 102 includes Fe-based material. In one embodiment, shape memory alloy 102 includes Cu-based material.

In one embodiment, the advantages of a high damping force and stable hysteretic behavior of steel from steel portion 101 and the superelastic characteristics of the shape memory alloy (e.g., Ni—Ti) 102 are combined to form hybrid cushion damper 100 with high energy dissipation and self-centering capability.

In one embodiment, steel portion 101 and shape memory alloy 102 are fixed to each other by an engineered bolt configuration 103.

In one embodiment, the number of curves of shape memory alloy 102 is based on the outer dimensions of steel portion 101 of hybrid cushion damper 100. For example, as the outer dimensions of steel portion 101 increase, the number of curves of shape memory alloy 102 of hybrid cushion damper 100 is increased.

In one embodiment, shape memory alloy 102 is employed to improve the horizontal behavior of hybrid cushion damper 100. In one embodiment, shape memory alloy 102 also improves the vertical behavior of hybrid cushion damper 100.

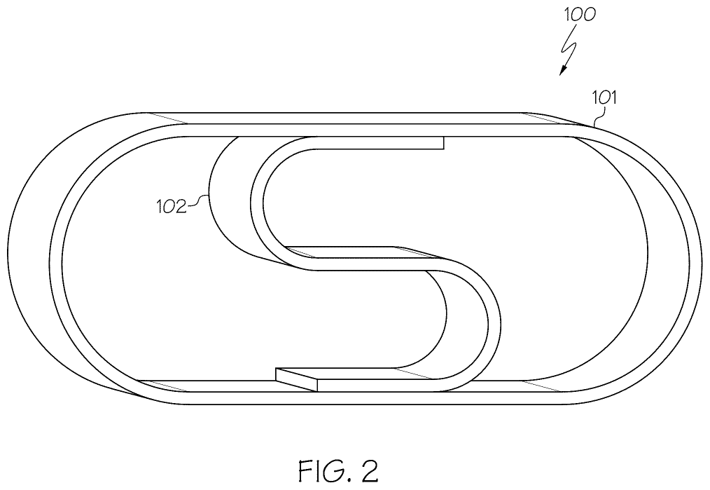

FIG. 2 illustrates the finite element model of hybrid cushion damper 100 in accordance with an embodiment of the present disclosure.

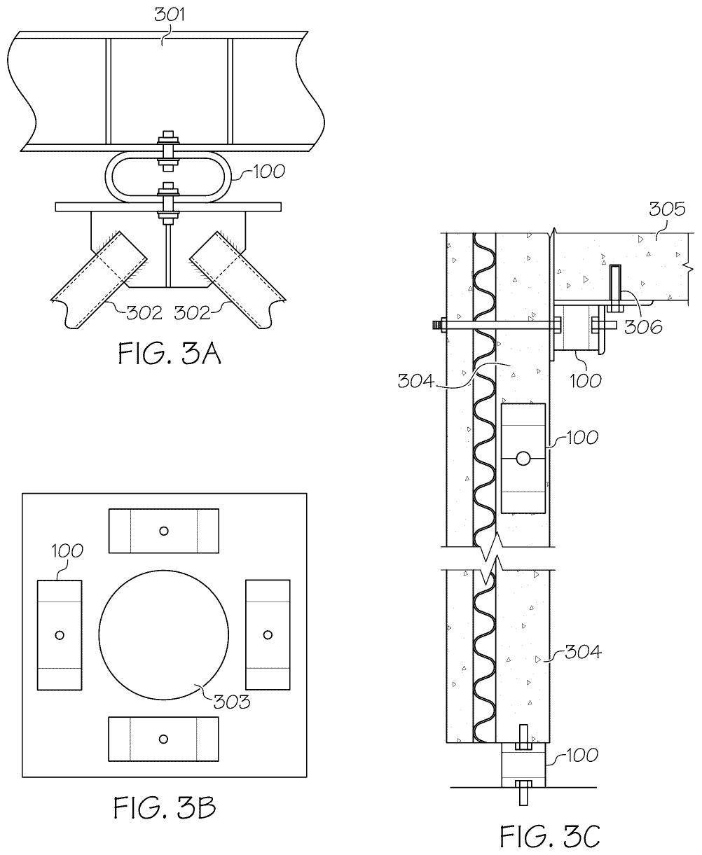

Such energy dissipative cushions, such as hybrid cushion damper 100, can be utilized to enhance the seismic performance of structures with proper connections as illustrated in FIGS. 3A-3C. FIGS. 3A-3C illustrate application scenarios of the hybrid cushion damper (e.g., hybrid cushion damper 100) in accordance with an embodiment of the present disclosure.

Referring to FIG. 3A, FIG. 3A illustrates the application of hybrid cushion damper 100 via a steel beam-brace connection, where hybrid cushion damper 100 connects beam 301 and braces 302.

Referring to FIG. 3B, FIG. 3B illustrates the application of hybrid cushion damper 100 as an isolation system for bridges, where a rubber bearing 303 (device which permits constrained relative motion between two parts—rotation or linear movement) is surrounded by hybrid cushion dampers 100.

Referring to FIG. 3C, FIG. 3C illustrates the application of hybrid cushion damper 100 connected to or integrated in the precast cladding panel connections 304. In one embodiment, such precast cladding panel connections 304 are connected to a beam 305 containing an epoxy that forms a top connection 306 connected to one of the hybrid cushion dampers 100.

In one embodiment, such hybrid cushion dampers 100 limit the displacement demands of seismically isolated bridges and avoid pounding and/or girder unseating.

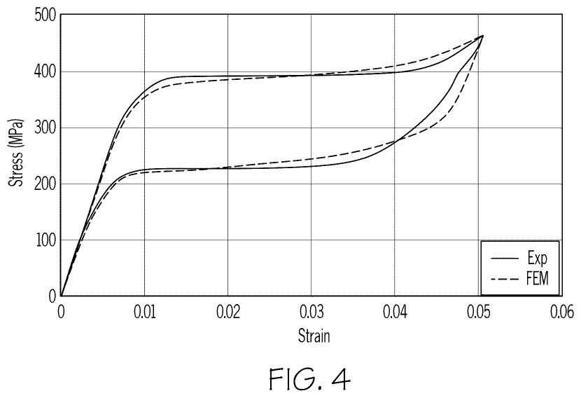

As discussed below, the horizontal behavior of cushion dampers with shape memory alloy 102 was investigated. In particular, the material behavior was investigated as shown in FIG. 4.

FIG. 4 shows the model-predicted (labeled as finite element model (FEM)) and the experimental tensile stress vs. strain response of the Ni—Ti material (material of shape memory alloy 102) at room temperature in accordance with an embodiment of the present disclosure. In this material point test, the sample was subjected to a uniaxial tensile strain of 5% and then unloaded from this strain magnitude to zero stress. It is seen that the superelastic material (material of shape memory alloy 102) can recover almost all of the induced deformation once it is unloaded from the 5% strain. Moreover, there is a good correlation between the experiment and model results. The area within the hysteresis loop characterizes the dissipated energy per unit volume of the material.

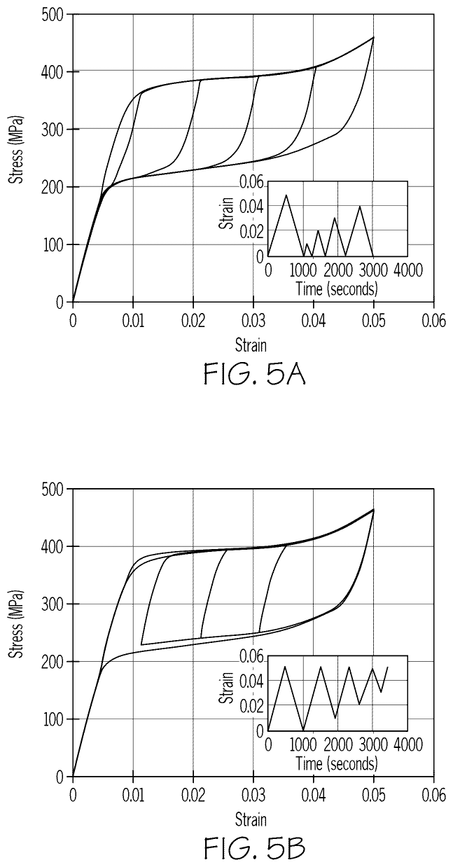

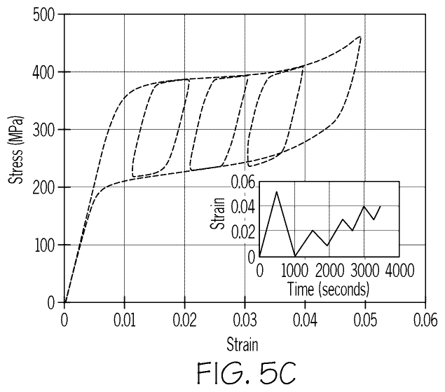

FIGS. 5A-5C illustrate the model responses of the superelastic Ni—Ti (material of shape memory alloy 102) under varying strain paths in accordance with an embodiment of the present disclosure.

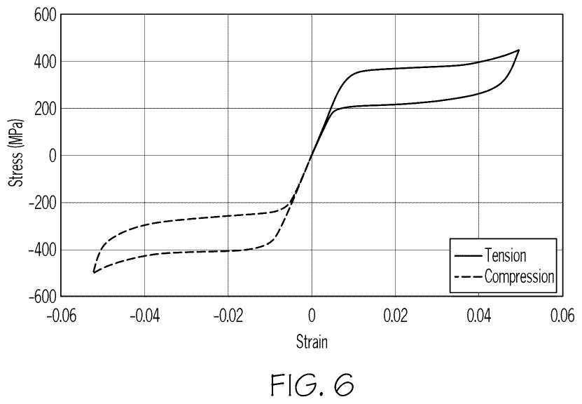

In particular, FIGS. 5A-5C illustrate the different hysteretic responses exhibited by the material when subjected to varying strain paths, all indicating the high energy dissipative properties of the Ni—Ti of shape memory alloy 102. In one embodiment, in applications where the alloy can experience stress reversals, the differences in material responses under compression are modeled (to ascertain the tension-compression asymmetry (TCA) effects). Lacking the compression component of the experimental plot, only the model-predicted responses are shown in FIG. 6.

FIG. 6 illustrates the model stress versus stress response of superelastic Ni—Ti under the tensile and compressive strain of ±0.05 to demonstrate the effect of the TCA model parameters (c, d) in accordance with an embodiment of the present disclosure.

As shown in FIG. 6, it is seen that under the same targeted strain of 0.05, the stresses obtained in the tensile case are slightly lesser than the case of compression, i.e., the tensile stress of 450 MPa and compressive stress of 500 MPa. The tension-compression asymmetry is attributed to the crystallographic asymmetry of the martensitic phase transformation. The model parameters c, and d are used to account for the intensity of asymmetry in stress-strain behaviors when shape memory alloy 102 is loaded in tension versus compression versus shear (i.e., TCA effects).

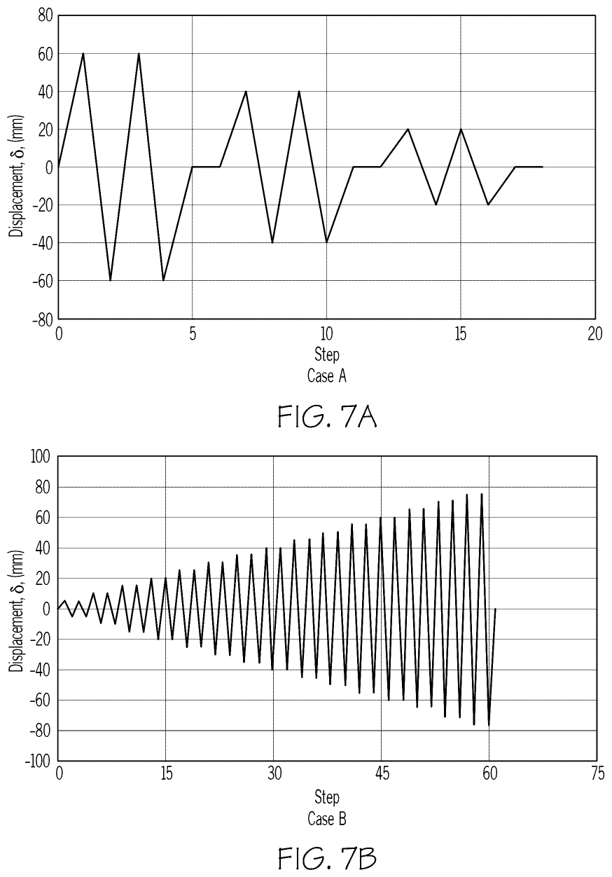

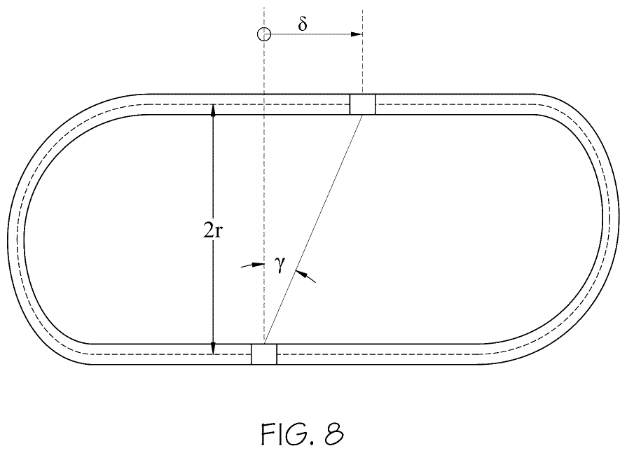

In one embodiment, two main cyclic loading protocols, labeled as case A and case B, are considered under the same boundary to study the performance characteristics of the shape memory alloy 102 (also referred to herein as “SmaC”) under varying load-displacement patterns as shown in FIGS. 7A-7B.

FIGS. 7A-7B illustrate case A and case B, respectively, in connection with the imposed cyclic loadings to finite element models (FEMs) in accordance with an embodiment of the present disclosure.

As illustrated in FIGS. 7A-7B, in these simulations, the maximum shear angle γ, as defined in FIG. 8 in accordance with an embodiment of the present disclosure, was 0.75 rad. Specifically, the displacement protocol given as case A is important for the energy-based seismic design to demonstrate that deformations may increase after ultimate cycles. Hence, the duration-related cumulative damage is to be considered.

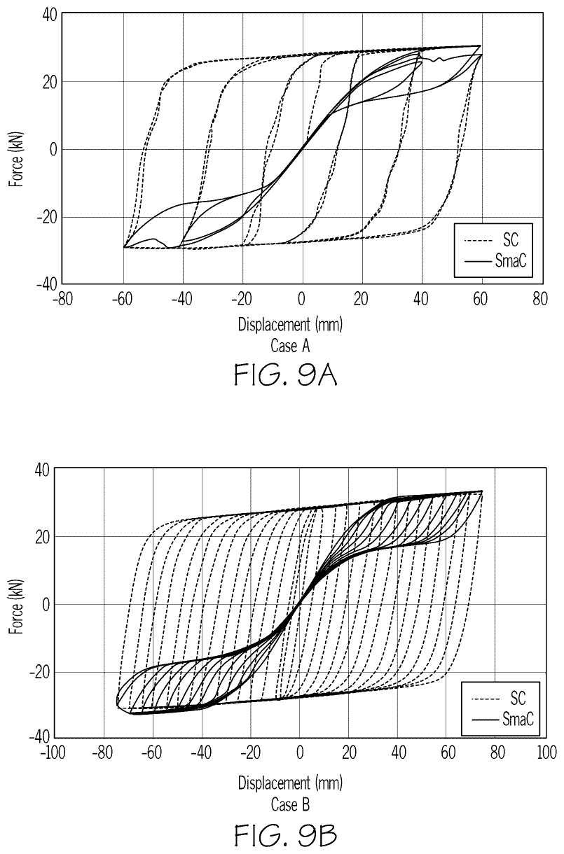

The force vs. displacement history of the identical SmaC 102 and steel 101 (also referred to herein as “SC”) under cases A and B are compared in FIGS. 9A and 9B, respectively.

FIGS. 9A-9B illustrate displacement (in mm) for case A and B, respectively, versus force (kN) in accordance with an embodiment of the present disclosure.

Unlike the case of the elastoplastic steel material, it is seen here that there is no residual displacement at the end of each cycle in the SmaC 102. Looking at the results for case A, there is an increase in the force from zero to a value of 28 KN at the end of the first cycle displacement of 60 mm. Upon unloading to zero displacement and reloading on the (opposing side), the force changed from zero to −30 kN (in the compression side). For case B, the maximum force obtained at the end of +75 mm displacement was 33.133 kN. Between 40 and 75 mm displacement, there is no significant difference between the force measured. In particular, only a change of about 1.187 kN occurs in the tensile side and 0.391 kN on the compression side between ±40 mm and ±75 mm. This is related to the material point behavior in FIGS. 5A-5C, where a significant portion of the stress-strain response is dominated by the middle (almost flat) plateau region signifying the state of the material dominated by the reoriented/detwinned martensite variants (between strains of 0.012 and 0.046). It is noted that in the characterization of the present model, the effect of the geometry or post-processing treatment of the test coupons on the material response was not accounted for. Rather, it was assumed that the observed stress-strain responses in FIG. 4 reflected the final intrinsic material point behavior of SmaC 102.

General characteristics of the force-displacement histories of SmaC 102 and SC 101 are also compared in Table 1:

| | |
|---|---|
| Case A | Case B |

| Parameter | SmaC | SC | SmaC | SC |
|---|---|---|---|---|
| Initial Stiffness | 1.083 | 5.385 | 1.087 | 5.284 |
| (kN/mm) | | | | |
| Secant Stiffness | 0.508 | 0.503 | 0.446 | 0.412 |
| (kN/mm) | | | | |
| Yielding Force | 20.153 | 24.658 | 20.223 | 24.053 |
| (kN) | | | | |
| Ultimate Force | 30.424 | 30.176 | 33.214 | 30.669 |
| (kN) | | | | |
| Damping Ratio | 8.045 | 52.279 | 9.827 | 53.448 |
| (%) | | | | |
| Residual Disp. | 0.000 | 52.084 | 0.000 | 67.171 |
| (mm) | | | | |

The initial stiffness of SmaC 102 is considerably lower than SC 101. However, the secant stiffnesses of the dampers, that were calculated at the maximum displacement level, are similar between the two cushion types. It is found for both loading cases that the yielding forces of SmaC 102 and SC 101 are about 20 and 24 kN, respectively. In loading case A, the ultimate forces of the dampers were similar. Since hardening is more evident for shape memory alloys, the ultimate force of SmaC 102 is almost 10% higher than that of the SC 101. The foremost differences between the dampers were related to damping ratio and residual displacement. The residual displacements of SmaC 102 were nearly zero in the two loading cases in contrast to that of SC 101 where a maximum residual displacement of 67.17 mm was evaluated. Consequently, the equivalent damping ratio of SC 101 is calculated to be ˜53% while it is found to be 8-10% for SmaC 102.

In all cycles, the forces read almost zero every time the applied displacement is brought to zero in both cases. Comparing FIGS. 9A-9B to FIG. 4, it is seen that the tension-compression asymmetry (TCA) in the Ni—Ti responses is less noticeable in the structural SmaC simulation when compared to the material point characterization. This is because the material in the structural form interacts with the geometry of the device and hence becomes subjected to non-homogeneous conditions which affect the “true” material response. Notwithstanding, the presence of the shape memory alloy endues the damper with high recentering capability. The hardening nature of the shape memory alloy material attempted to limit the deformations that occur during the cyclic loading, while the superelastic, recentering feature tended to restore the structure to the original state.

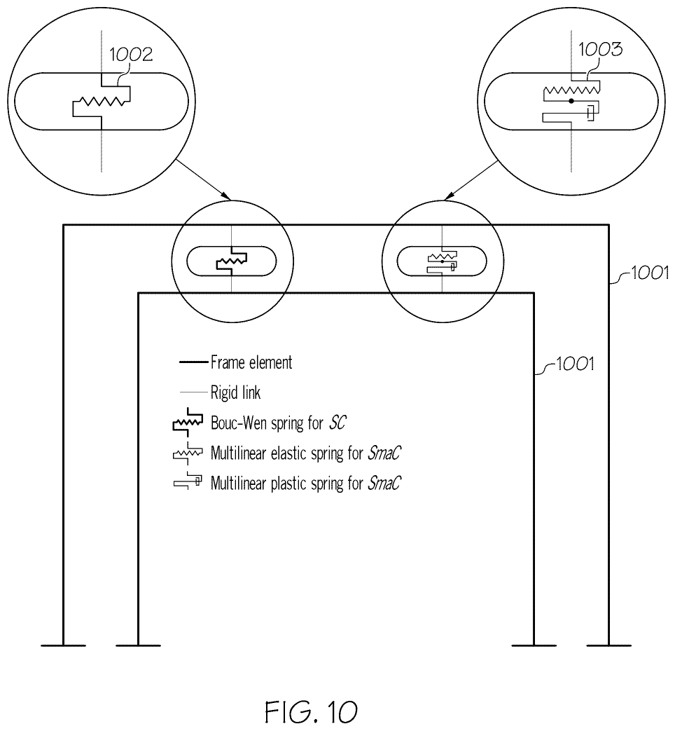

Furthermore, in order to compare the effect of the distinct cushions for retrofitting purposes of a testing frame with the dampers, numerical models of the testing frame are generated. In one embodiment, the simulations are performed using SAP2000® FE software. The frame is representative of residential buildings in Turkey with a 4.0 m length and 3.0 m height. The columns and beams have a 300×300 mm² cross-section. Columns have 8Ø16 longitudinal reinforcement. The beam has 3Ø14 longitudinal reinforcements at the top and bottom sections. All of the elements have Ø10/10-20 transversal reinforcement. The foundation of the frame has 400 mm thickness, 4,500 mm length, and 1,300 mm width. An example of a numerical model is depicted in FIG. 10.

FIG. 10 illustrates the numerical modeling strategy in accordance with an embodiment of the present disclosure. In such numerical models, the numerical models incorporate SC 101 and SmaC 102 to investigate residual displacements of the moment resisting frames 1001.

In the numerical model, the nonlinear behaviors of the frame elements are defined by fiber hinges, whereas, the hysteretic behaviors of the cushions are represented with link elements. The Bouc-Wen model 1002 is employed for SC 101, while multiple multilinear elastic and plastic links 1003 with a pivot hysteresis model are utilized to define the superelastic behavior of SmaC 102. A secondary frame, designed by using IPE220 steel profile, is also modeled to fix the cushions to the mainframe.

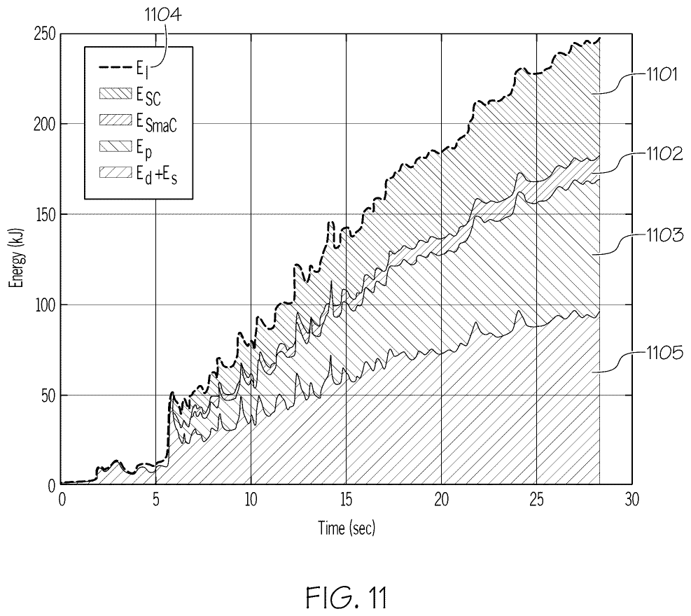

Referring now to FIG. 11, FIG. 11 compares the energy dissipated by SC (E_{SC}) (see area 1101), SmaC (E_{SmaC}) (see area 1102), and the structural members (Eₚ) (see area 1103) in accordance with an embodiment of the present disclosure.

As shown in FIG. 11, area 1102 is significantly smaller in comparison to area 1101. Furthermore, it is noted that the area enclosed by 1101 and 1102 shows the reduction of damage on the structural members.

Furthermore, FIG. 11 illustrates E₁ 1104 (the total input energy) and E_{d}+Eₛ 1105 (E_{d} is the damping energy and Eₛ is the strain energy).

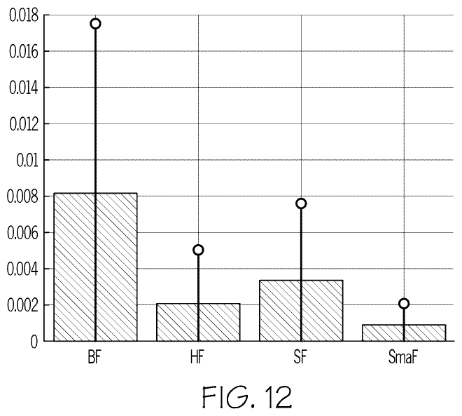

Referring to FIG. 12, FIG. 12 illustrates the residual drift responses of the moment resisting frames with different cushion damper arrangements in accordance with an embodiment of the present disclosure.

In FIG. 12, residual drafts of the frame were compared for the bare frame (BF), the frame having only SC (SF), the frame having only SmaC (SmaF), and the frame having both SC and SmaC (HF). FIG. 12 illustrates that the use of SmaC, including the frame having both SC and SmaC, significantly reduces the residual drifts.

Based on the numerical analyses discussed herein, the damper of the present disclosure can dissipate significant energy while reducing the residual displacements.

Furthermore, the damper of the present disclosure provides both high energy dissipation and self-centering capability. Additionally, the engineered shape of the damper allows its versatile use.

Furthermore, the damper of the present disclosure addresses the drawbacks of prior energy dissipation systems, such as loading velocity rate dependency, loss of viscosity and residual displacements of the main structure. Such drawbacks are addressed by combining the advantages of two different materials, namely, the high damping force and stable hysteretic behavior of steel and the superelastic characteristics of the shape memory alloy through its engineered geometry.

Additionally, the damper of the present disclosure reduces damage to structural members. By absorbing and dissipating energy from natural hazards, these designs can significantly reduce the amount of damage to structural members. This can lead to lower repair and replacement costs as well as reduced downtime.

Furthermore, the damper of the present disclosure improves safety and resilience. Structures that are designed to dissipate energy from natural hazards are more likely to remain standing and functional after an event. This can help to protect people and property from harm.

Additionally, the damper of the present disclosure enhances performance, such as enhancing the performance of structures under extreme loading conditions. This can be particularly beneficial for critical infrastructure, such as bridges and dams.

Furthermore, the damper of the present disclosure reduces the environmental impact. By reducing the amount of damage caused by natural hazards, energy dissipation systems of the present disclosure can help to reduce the environmental impact of these events. This can lead to cleaner air and water as well as reduced greenhouse gas emissions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

1. A damper, comprising:
a steel portion; and
a shape memory alloy portion, wherein said steel portion and said shape memory alloy portion are fixed to each other.

2. The damper as recited in claim 1, wherein said steel portion and said shape memory alloy portion are fixed to each other by a bolt configuration.

3. The damper as recited in claim 1, wherein said steel portion has an oval shape.

4. The damper as recited in claim 1, wherein said shape memory alloy portion is in an S-shape form.

5. The damper as recited in claim 4, wherein a number of curves of said shape memory alloy portion is based on an outer dimension of said steel portion.

6. The damper as recited in claim 1, wherein said steel portion provides a damping force.

7. The damper as recited in claim 1, wherein said shape memory alloy portion provides self-centering to said damper.

8. The damper as recited in claim 1, wherein said shape memory portion comprises Ni—Ti, Fe, or Cu.

9. The damper as recited in claim 1, wherein said damper is utilized in a steel beam-brace connection.

10. The damper as recited in claim 1, wherein said damper is utilized in an isolation system for a bridge.

11. The damper as recited in claim 1, wherein said damper is utilized in a precast cladding panel connection.
